(19) United States
(12) Patent Application Publication
(10) Pub. No.: US 2005/0188539 A1
(43) Pub. Date: Sep. 1, 2005

(54) Shaving blade unit

(76) Inventors: John Prudden JR., Essex, MA (US); Stephen Rawle, Newbury (GB); Anne Stewart, Reading (GB); Roy Nicoll, Workinghman (GB)

Correspondence Address: FISH & RICHARDSON PC, 225 FRANKLIN ST, BOSTON, MA, 02110, US

(21) Appl. No.: 10/787,289

(22) Filed: Feb. 26, 2004

(51) Int. Cl. B26B 19/44

(52) U.S. Cl. 30/41

(57) ABSTRACT

A shaving blade unit including a housing, at least one elongated blade having a cutting edge on the housing, an elongated guard on the housing in front of the blade, and an elongated cap on the housing behind the blade. The guard includes an elongated guard strip for delivering a shaving aid and elastomeric guard fins extending laterally beyond the ends of the guard strip. The guard can also include elastomeric material including a series of depressions. The cap can also include elastomeric cap fins on both sides of the cap strip extending laterally beyond the ends of the cap strip.

### BACKGROUND OF THE INVENTION

The invention relates to shaving razors, and blade units therefore and methods of manufacture.

Shaving razors often include a plurality of blades that are secured in a desired position in a plastic housing. The housing is often provided with a guard with fins or other skin engaging structures made of elastomeric material in front of the blades, and a cap on which the skin can slide behind the blades. A shaving aid (e.g., a lubricant agent dispensing mechanism) can be incorporated into the cap and, in some cases, the guard. The blades can be stationary or movable, and the housing can be fixed to a handle or movably mounted on the handle, to, e.g., assist in following the contours of the skin during shaving.

Examples of some different types of shaving razors are described in U.S. Pat. Nos. 5,903,979, 6,185,823, and 6,553,641.

### SUMMARY OF THE INVENTION

In one aspect, the invention features, in general, a shaving blade unit including a housing, at least one elongated blade having a cutting edge on the housing, an elongated guard on the housing in front of the blade, and an elongated cap on the housing behind the blade. The guard includes an elongated guard strip for delivering a shaving aid and elastomeric guard fins extending laterally beyond the ends of the guard strip.

In another aspect, the invention features, in general, a shaving blade unit including a housing, at least one elongated blade, an elongated guard, and an elongated cap where the guard includes an elongated guard strip for delivering a shaving aid and an elastomeric material including a series of depressions.

In another aspect, the invention features, in general, a shaving blade unit including a housing, at least one elongated blade, an elongated guard, and an elongated cap, where the cap includes an elongated cap strip for delivering a shaving aid and elastomeric cap fins on both sides of the cap strip extending laterally beyond the ends of the cap strip.

Particular embodiments of the invention may include one or more of the following features. The series of depressions in the guard can be are arranged in a row that is parallel to the elongated guard strip, and the row can be in front of and or behind the guard strip. Preferably there are two rows, one in front and one behind. The guard fins can be curved. The cap fins can be curved. The blade unit can be a diposable cartridge including handle connection structure.

In another aspect, the invention features, in general, a shaving razor including a shaving blade unit as already described and a handle attached thereto.

Embodiments of the invention may include one or more of the following advantages. Fins on the side of shaving aid strips provides for skin management in gripping the sides more than the middle, both at the guard and the cap. The depressions can receive and gradually deliver shaving aid material delivered by the shaving aid strips. The central position for the lubricating strip on the guard can provide improved shaving performance.

Other advantages and features of the invention will be apparent from the following description of particular embodiments and from the claims.

### BRIEF DESCRIPTION OF THE DRAWINGS

FIG. 1 is a perspective view of a shaving blade unit.

FIG. 2 is a plan view of the FIG. 1 shaving blade unit.

FIG. 3 is a front elevation of the FIG. 1 shaving blade unit.

FIG. 4 is a rear elevation of the FIG. 1 shaving blade unit.

FIG. 5 is a bottom view of the FIG. 1 shaving blade unit.

FIG. 6 is a side elevation of the FIG. 1 shaving blade unit.

### DETAILED DESCRIPTION OF PARTICULAR EMBODIMENTS

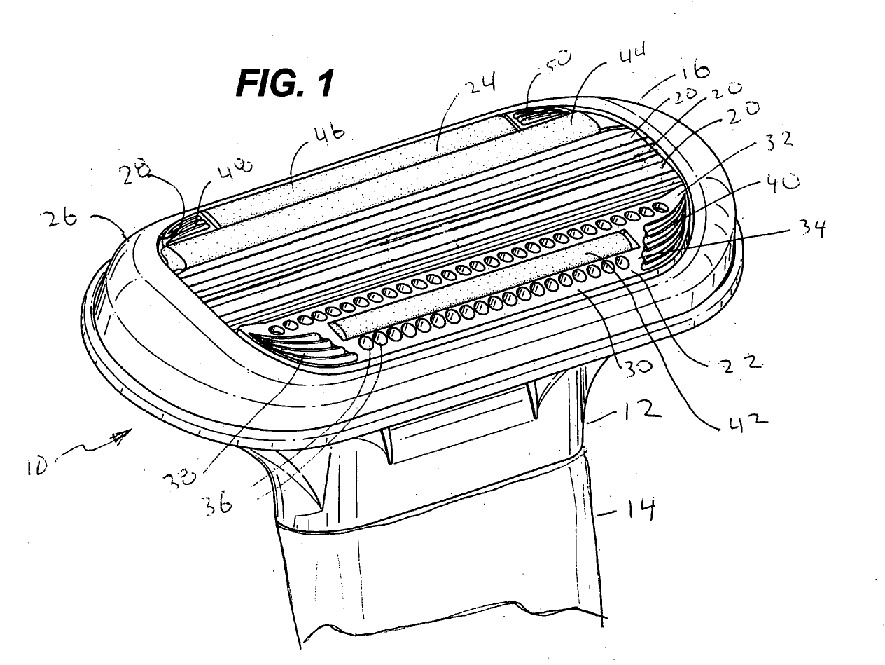

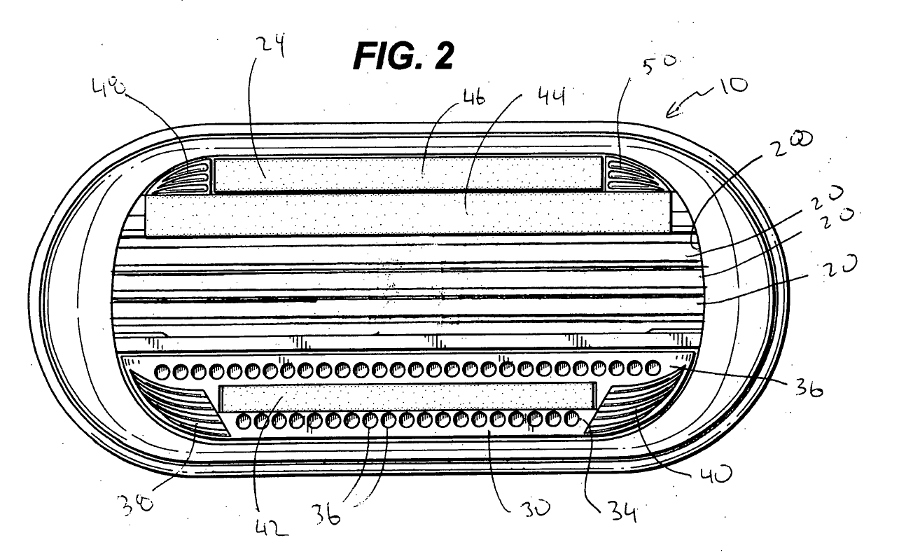

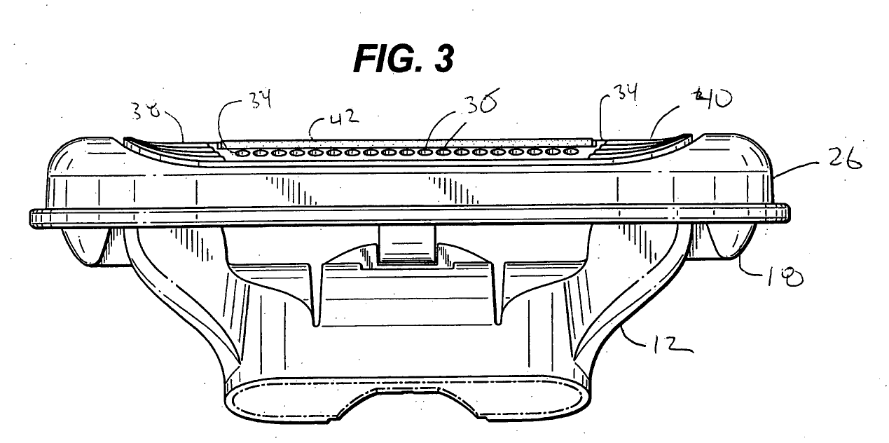

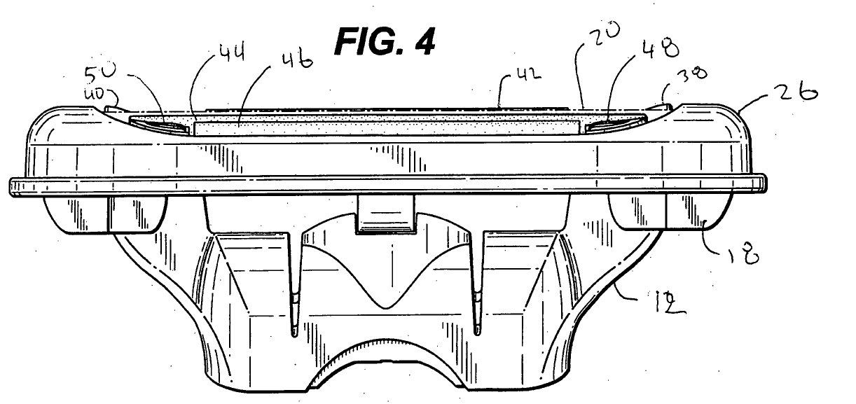

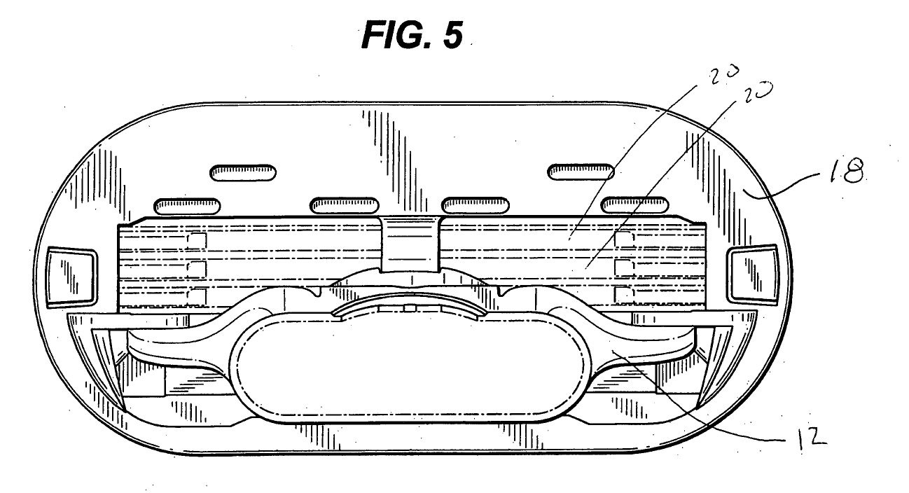

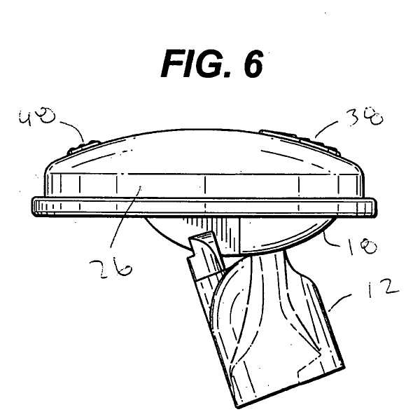

Referring to the FIGS. 1-6, shaving blade unit 10 includes a base member 12, for connection to handle 14, and shaving blade assembly 16, which is pivotally connected to base member 12. Shaving blade assembly 16 includes plastic housing 18 (most visible in FIG. 5) that carries three blades 20, guard 22, and cap components 24, and formed, sheet metal clip 26 that holds blades 20 in place is secured to housing 18 around its periphery by a snap-fit connection. Clip 26 has opening 28 through which blades 20, guard 22 and cap components 26 are exposed.

Guard 22 includes an elastomeric member 30 in which two rows 32, 34 of circular depressions 36 are formed at the front and the back and curved fins 38, 40 are formed on the two sides, extending beyond the ends of elongated central shaving aid strip 42 (providing lubrication), which is secured within elastomeric portion 30. Depressions 36 are cylindrical and have a diameter of 0.8 mm, a depth of 0.62 mm and are spaced from each other by a distance of 1.05 mm. Depressions 36 in front row 32 are offset from depressions 36 in rear row 34. Shaving aid strip 42 bulges upward from the surface of elastomeric member 30. There are four fins 38, and four fins 40; the fins in front extend slightly in front of the ends of the lubrication strip 42, and each fin behind the front fin, begins from a slightly outward position. The outward ends of the fins 38, 40 curve backward, approximating the curve of opening 28 in clip 26. The fins tend to grab the user's skin more at the side than in the middle.

Cap components 26 include front elongated shaving aid strip 44, rear elongated shaving aid strip 46, and elastomeric fins 48, 50 extending beyond the ends of elongated strip 46. Fins 48, 50 all begin at a position just beyond the ends of lubrication strip 46, and the outer ends tend to curve forward, approximating the curve of opening 28 in clip 26. Fins 48, 50 protect the user's skin from the edge of clip 28 in the corner region and also manage skin in grabbing it at the side but not in the middle. Also, if a user places the cartridge face down on a surface, fins 48, 50 raise the shaving aid strips 44, 46 above a surface to permit them to dry and avoid sticking to the surface. The use of two shaving aid strips permits one provide two different types of shaving aids (e.g., different lubricants or a lubricant and another aid such as a whisker softener or medicinal agent), providing flexibility in controlling shaving performance.

Shaving aid strips 42, 44, 46 can be made of polyethylene oxide and polystyrene, as described, e.g., in U.S. Pat. No. 4,170,821, which is hereby incorporated by reference.

Other embodiments of the invention are within the scope of the appended claims.

1. A shaving blade unit comprising
a housing,
at least one elongated blade having a cutting edge on said housing,
an elongated guard on said housing in front of said blade that is parallel to said cutting edge, and
an elongated cap on said housing behind said blade and parallel to said cutting edge,
said guard including an elongated guard strip for delivering a shaving aid parallel to said cutting edge, said guard strip having guard strip ends, and said guard including elastomeric guard fins extending laterally beyond said guard strip ends.

2. A shaving blade unit comprising
a housing,
at least one elongated blade having a cutting edge on said housing,
an elongated guard on said housing in front of said blade that is parallel to said cutting edge, and
an elongated cap on said housing behind said blade and parallel to said cutting edge,
said guard including an elongated guard strip for delivering a shaving aid parallel to said cutting edge and an elastomeric material including a series of depressions.

3. A shaving blade unit comprising
a housing,
at least one elongated blade having a cutting edge on said housing,
an elongated guard on said housing in front of said blade that is parallel to said cutting edge, and
an elongated cap on said housing behind said blade and parallel to said cutting edge,
said cap including a first elongated cap strip for delivering a shaving aid parallel to said cutting edge and elastomeric cap fins on both sides of said strip extending laterally beyond said ends.

4. The shaving blade unit of claim 1 wherein said guard includes an elastomeric material including a series of depressions.

5. The shaving blade unit of claim 1 wherein said cap includes a first elongated cap strip for delivering a shaving aid parallel to said cutting edge, said cap strip having cap strip ends, and said cap having elastomeric cap fins extending laterally beyond said cap strip ends.

6. The shaving blade unit of claim 2 wherein said cap includes a first elongated cap strip for delivering a shaving aid parallel to said cutting edge, said cap strip having cap strip ends, and said cap having elastomeric cap fins extending laterally beyond said cap strip ends.

7. The shaving blade unit of claim 4 wherein said cap includes a first elongated cap strip for delivering a shaving aid parallel to said cutting edge, said cap strip having cap strip ends, and said cap having elastomeric cap fins extending laterally beyond said cap strip ends.

8. The blade unit of claim 2, 4 or 7 wherein said series of depressions are arranged in a first row that is parallel to said elongated guard strip.

9. The blade unit of claim 2, 4 or 7 wherein said series of depressions are arranged in a first row that is parallel to said elongated guard strip and located in front of said elongated guard strip.

10. The blade unit of claim 2, 4 or 7 wherein said series of depressions are arranged in a first row that is parallel to said elongated guard strip and located behind said elongated guard strip.

11. The blade unit of claim 2, 4 or 7 wherein said series of depressions are arranged in a first row that is parallel to said elongated guard strip and located in front of said elongated guard strip and in a second row that is parallel to said elongated guard strip and located behind said elongated guard strip.

12. The blade unit of claim 1, 4, 5, or 7 wherein said guard fins are curved.

13. The blade unit of claim 3, 5, 6, or 7 wherein said cap fins are curved.

14. The blade unit of claim 5 or 7 wherein said guard fins are curved and wherein said guard fins are curved.

15. The blade unit of claim 1, 2 or 3 wherein said blade unit is a disposable cartridge including handle connection structure.

16. The blade unit of claim 3, 5 and 6 wherein said cap has a second elongated cap strip for delivering a shaving aid parallel to said cutting edge.

17. A shaving razor comprising the shaving blade unit of claim 1 and a handle attached thereto.

18. A shaving razor comprising the shaving blade unit of claim 2 and a handle attached thereto.

19. A shaving razor comprising the shaving blade unit of claim 3 and a handle attached thereto.
